(19) United States
(12) Patent Application Publication
(10) Pub. No.: US 2022/0288544 A1
(43) Pub. Date: Sep. 15, 2022

(54) INTEGRATED DIAPHRAGM PUMP

(71) Applicant: XIAOWEI (SHANGHAI) BIOTECHNOLOGY CO., LTD, Shanghai (CN)

(72) Inventors: Zunfeng LIU, Shanghai (CN); Ji XUE, Shanghai (CN); Yunting ZHANG, Shanghai (CN); Zhi Yuan RUAN, Shanghai (CN); Kai Li SHENG, Shanghai (CN); Ping FANG, Shanghai (CN)

(73) Assignee: XIAOWEI (SHANGHAI) BIOTECHNOLOGY CO., LTD, Shanghai (CN)

(21) Appl. No.: 17/634,502

(22) PCT Filed: Jul. 22, 2020
(86) PCT No.: PCT/CN2020/103390

§ 371 Date: Feb. 10, 2022

(30) Foreign Application Priority Data
Aug. 12, 2019 (CN) 201921293798.8
Apr. 15, 2020 (CN) 202020556116.4
Jul. 20, 2020 (CN) 202010700578.3

(51) Int. Cl. B01F 25/31; A47K 5/16

(52) U.S. Cl. CPC B01F 25/3111; A47K 5/16; F04B 43/04

(57) ABSTRACT

Disclosed is an integrated diaphragm pump, comprising a first stop plate (1), a foaming member (2), a valve plate (5), a diaphragm (7), and a motor (10), wherein the foaming member (2) comprises a gas-liquid mixing tank (21) and a foaming cavity, and an outlet of the gas-liquid mixing tank (21) is in communication with the foaming cavity for mixing a gas and a liquid and foaming same by means of the foaming cavity. The integrated diaphragm pump has the advantages of being high in integration and small in size.

### TECHNICAL FIELD

The present invention relates to the technical field of fluid conveying devices, in particular to an integrated diaphragm pump.

### BACKGROUND

In daily life, it is often necessary to use pumps to convey various fluids, for example, the diaphragm pumps are applied to hand washing machine, fragrance machines, etc. Generally, a hand washing machine and a fragrance machine each include a liquid storage bottle, a diaphragm pump and a fluid conveying channel. The diaphragm pump outputs the liquid pumped from the liquid storage bottle and through the fluid conveying channel to use by users.

For the convenience of use, the existing hand washing machines and fragrance machines often include sensing devices, such as infrared sensing devices. In order to install infrared sensing devices, it is necessary to additionally provide infrared sensing device mounts or accommodating cavities in the diaphragm pump, which will undoubtedly increase the number of parts and assembly difficulty of the diaphragm pump.

In addition, when the diaphragm pump is used to convey two or more substances, a mixing device is also provided at the outlet end of the diaphragm pump, so as to achieve the purpose of uniform mixing. For example, in order to fully mix the liquid and gas and produce uniform foam, a foaming device is provided between the discharge valve plate and the foam outlet. Generally, the foaming device includes a plurality of parallel and stacked filter screens, and the gas and liquid discharged from the diaphragm pump are fully mixed and foamed in the process of sequentially passing through the filter screens. However, the foaming device has the disadvantages of complex structure, complicated assembly, and large volume.

The present application is submitted to address above problems.

### SUMMARY

In view of this, the present invention aims to provide an integrated diaphragm pump to address the problems of numerous parts, difficult assembly and large volume of the existing diaphragm pump.

In order to achieve the above objective, the technical scheme of the present invention is achieved as follows:

An integrated diaphragm pump, comprising a first stop plate, a foaming member, a valve plate, a diaphragm and a motor arranged in sequence, wherein the said foaming member includes a gas-liquid mixing tank and a foaming cavity, an outlet of the gas-liquid mixing tank communicates with the foaming cavity for mixing gas and liquid and foaming through the foaming cavity thereof.

Further, the foaming member includes a plurality of foaming cavities, and a foaming channel is arranged between any two adjacent foaming cavities in a foam flowing direction.

Further, a foaming channel is provided between the gas-liquid mixing tank and the adjacent foaming cavity.

Further, the foaming member includes a foam outlet end, which includes a second foaming groove and a foam discharge port that communicate with each other, and an outlet of the foaming cavity communicates with an inlet of the foam discharge port through the second foaming groove, and a foaming channel is arranged between the outlet of the foaming cavity and the second foaming groove.

Further, the foaming channel is at least provided one of horizontally, vertically and obliquely.

Further, the foaming member includes a foaming device and a second stop plate, wherein the foaming device is arranged between the first stop plate and the second stop plate, and the foaming device forms a foaming cavity through the first stop plate and the second stop plate located at both sides thereof.

Further, the foaming cavity comprises a plurality of sub-cavities, each sub-cavity is internally provided with a filter screen, and a foam channel is provided between each sub-cavity and the adjacent sub-cavity, through which the liquid and gas can pass through the filter screen in each sub sub-cavity sequentially.

Further, the foaming member is integrally formed, and the foaming member comprises a plurality of foaming cavities, and a lower partition plate is arranged between any two adjacent foaming cavities, and each lower partition plate is provided with the foaming channel.

Further, one end, towards the first stop plate, of the lower partition plate is provided with a second tooth structure with teeth gaps.

Further, one side, towards the foaming member, of the first stop plate is provided with an upper partition plate, and the upper partition plate extends into the foaming cavity, one end, near the foaming member, of the upper partition plate is provided with a first tooth structure, and the first tooth structure is provided with a tooth gap.

Compared with the prior art, the integrated diaphragm pump has the following advantages:
(1) According to the present invention, the structure of the integrated diaphragm pump is optimized, especially the foaming structure is integrated into the foaming member, which decreases the parts, lowers the assembly difficulty and reduces the volume.
(2) According to the integrated diaphragm pump provided by the present invention, the sensing device and the foaming device are integrated, which avoids providing the mounting seat mount or accommodation cavity separately, and makes the installation of the sensing device quick, simple and convenient to use.

To sum up, the integrated diaphragm pump according to the present application has the advantages of simple structure, quick assembly, high degree of integration and small volume.

### BRIEF DESCRIPTION OF THE DRAWINGS

The accompanying drawings, which form a part of the present invention, are used to provide a further understanding of the present invention. The illustrative embodiments of the present invention and descriptions thereof are used to explain the present invention, and do not constitute an improper limitation of the present invention. In the attached drawings:

FIG. 1 is a schematic structural diagram of an integrated diaphragm pump according to the present invention (after a first stop baffle is removed);

FIG. 2 is another structural diagram of an integrated diaphragm pump according to the present invention (after a first stop baffle is removed);

FIG. 3 is an explosive view of an integrated diaphragm pump according to the present invention;

FIG. 4 is a schematic diagram of the structure of a first stop baffle according to the present invention;

FIG. 5 is another structural schematic diagram of a first stop baffle according to the present invention;

FIG. 6 is a schematic diagram of the structure of a foaming device according to the present invention;

FIG. 7 is another structural schematic diagram of a foaming device according to the present invention;

FIG. 8 is a schematic diagram of another structure of an integrated diaphragm pump according to the present invention;

FIG. 9 is a schematic structural diagram of a first stop baffle in FIG. 8;

FIG. 10 is another structural schematic diagram of a first stop baffle in FIG. 8;

FIG. 11 is a schematic diagram of the structure of a foaming member in FIG. 8.

### DESCRIPTION OF REFERENCE SIGNS

1-first stop plate, 101-gas inlet, 102-communication groove, 103-first gas inlet, 104-mounting hole, 105-clamping groove, 106-first foam outlet tank, 107-upper partition plate, 108-first tooth structure, 2-foaming member, 21-gas-liquid mixing tank, 22-liquid outlet, 23-liquid inlet opening, 24-gas inlet opening, 25-first foaming cavity, 26-second foaming cavity, 27-third foaming cavity, 28-lower partition plate, 29-second tooth structure, 3-foaming device, 301-second gas inlet hole, 302-liquid inlet tank, 303-first gas outlet hole, 304-second gas outlet hole, 305-first sub-cavity, 306-first foam outlet, 307-second sub-cavity, 308-third sub-cavity, 309-second foam outlet, 310-fourth sub-cavity, 311-third foam outlet, 312-foam discharge port, 313-second foam outlet tank, 314-accommodation groove, 315-sensing window, 316-first side, 317-second side, 318-partition plate, 4-second stop plate, 401-liquid inlet, 5-valve plate, 6-valve base, 7-diaphragm, 8-diaphragm mount, 9-rotor compartment, 10-motor, 11-connector, 12-check valve, 13-sensing device, 14-foam outlet end.

### DETAILED DESCRIPTION

Hereinafter, the inventive concepts of the present disclosure will be described using terms commonly used by those skilled in the art to convey the essence of their work to others skilled in the art. However, these inventive concepts can be embodied in many different forms, and therefore should not be regarded as limited to the embodiments described herein.

In addition, the terms “first” and “second” are only used for descriptive purposes, and cannot be understood as indicating or implying relative importance or implicitly indicating the number of indicated technical features. Therefore, the features defined with “first” and “second” can explicitly or implicitly include at least one of such features. In the description of the present invention, “plural” means at least two, including two and three, unless otherwise explicitly and specifically limited.

It should be noted that the embodiments of the present invention and the features in the embodiments can be combined with each other without conflict.

The present invention will be described in detail with reference to the drawings and embodiments.

### Embodiment 1

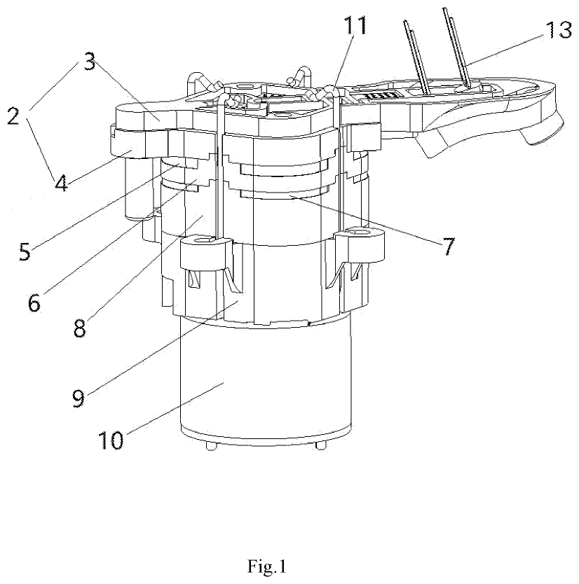

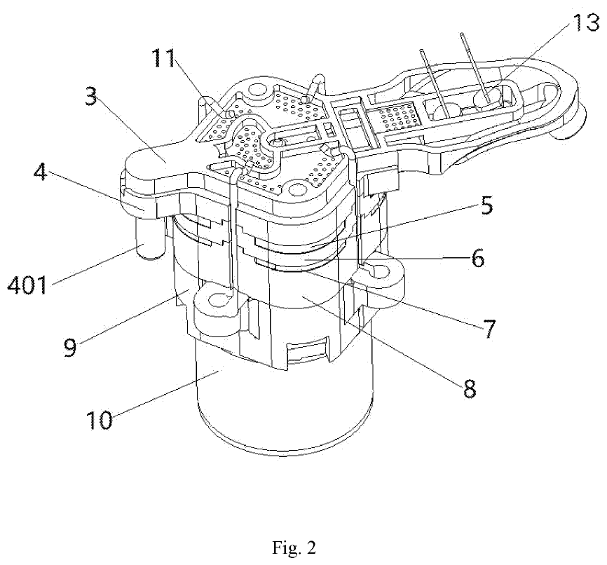

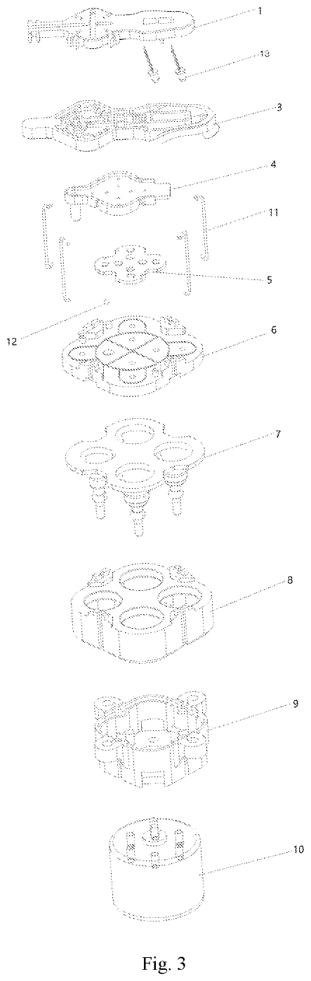

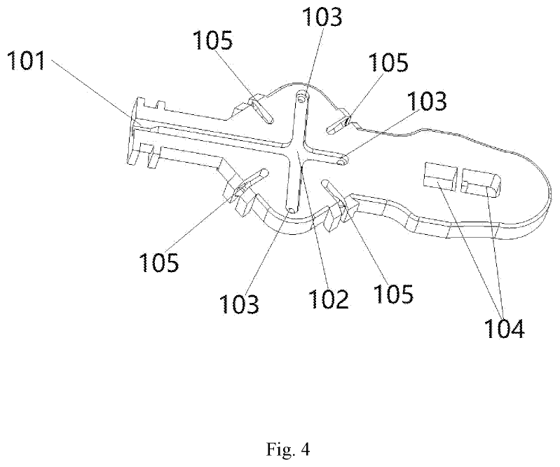

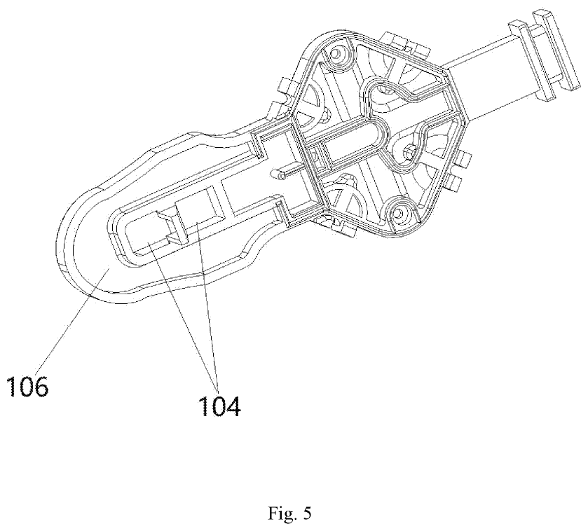

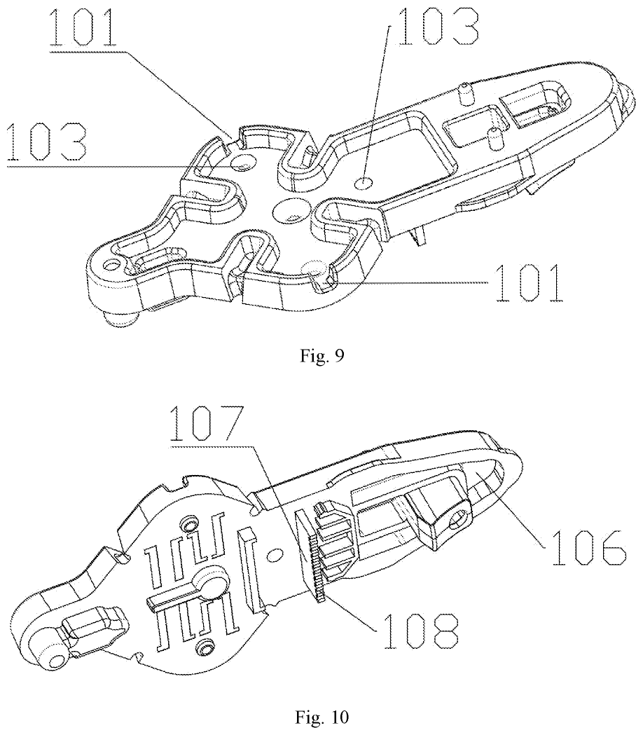

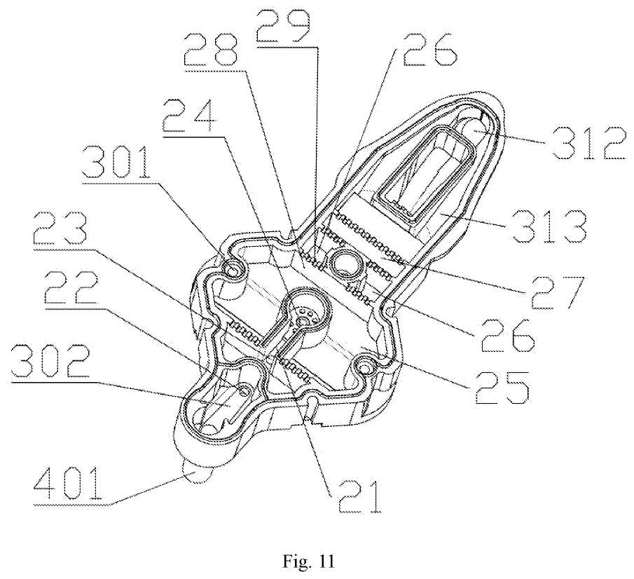

As shown in FIGS. 1-11, the embodiment provides an integrated diaphragm pump, comprising a first stop plate 1, a foaming member 2, a valve plate 5, a diaphragm 7 and a motor 10, all of which are arranged in sequence, wherein the diaphragm 7 is provided with a plurality of diaphragm bins; when the diaphragm bins are used for sucking and discharging gas, the diaphragm bins are gas bins; when the diaphragm bins are used for sucking and discharging liquid, the diaphragm bins are liquid bins; the motor 10 can drive the diaphragm bins to be periodically stretched or compressed, and the valve plate 5 is provided with a liquid inlet valve plate, a liquid outlet valve plate, a gas inlet valve plate and a gas outlet valve plate; each gas bin has a gas inlet valve plate and a gas outlet valve plate corresponding to it one by one; each liquid bin has a liquid inlet valve plate and a liquid outlet valve plate corresponding to it one by one; when the gas bin is stretched to increase the volume, the gas inlet valve plate opens so that external gas can enter the gas bin; and when the gas bin is compressed to decrease the volume, the gas outlet valve plate is opened so that the gas in the gas bin is discharged. Similarly, when the liquid bin is stretched to increase the volume, the liquid inlet valve plate is opened so that external liquid can enter the liquid bin; and when the liquid bin is compressed to decrease the volume, the liquid outlet valve plate is opened so that the liquid in the liquid bin is discharged.

It is necessary to involve the flow and mixed foaming of gas and liquid in the foaming process, and the embodiment will introduce the relevant structure.

For the flow of gas, the first stop plate 1 is provided with a gas inlet 101 and a first gas inlet 103 which communicate with each other, the gas inlet 101 is connected to an external gas intake device, such as the atmosphere; the first gas inlet 103 and the gas bin are provided in one-to-one correspondence and communicate with each other. When in use, the gas is only fed into the gas inlet 101, and then driven by the motor 10 to enter the diaphragm 7 through the first gas inlet 103 respectively. The structure is simple, and the gas inlet 101 and first gas inlet 103 can be integrally provided on the first stop plate 1 to decrease the parts of the integrated diaphragm pump. Preferably, a plurality of first gas inlets 103 are provided on the first stop plate 1.

In which, a communication structure between the first gas inlet 103 is connected to the gas bin can be achieved by the following methods:

Method 1: The first gas inlet 103 directly penetrates through foaming member 2 to communicate the gas bin;

Method 2: The foaming member 2 is provided with a second gas inlet hole 301, and the second gas inlet hole 301, the gas bin and the first gas inlet 103 are all provided in one-to-one correspondence, and the first gas inlet 103 communicates with the gas bin through the second gas inlet hole 301.

As for the flow of liquid, the foaming member 2 comprises a liquid inlet 401 and a liquid inlet tank 302, wherein the liquid inlet 401 communicates with an external liquid supply device, and the liquid inlet tank 302 communicates with the liquid inlet 401 and is arranged corresponding to the liquid inlet valve plate. Therefore, driven by the motor 10 and as the liquid bin is stretched to increase the volume, the external liquid enters the liquid inlet tank 302 through the liquid inlet 401, and then enters the liquid bin of the diaphragm 7 through the liquid inlet valve plate.

For the foaming process, the foaming member 2 includes a gas-liquid mixing tank 21, a foaming cavity, a foam outlet end 14, wherein the gas-liquid mixing tank 21 communicates with the gas bin and the liquid bin of the diaphragm 7, that is, the gas inlet 101 and the liquid inlet 401 communicate with an inlet of the gas-liquid mixing tank 21 through the diaphragm 7, and are used for conveying gas and liquid to the gas-liquid mixing tank 21; an outlet of the gas-liquid mixing tank 21 communicates with the foam outlet end 14 through the foaming cavity for mixing the gas and the liquid, and then the mixture is discharged from the integrated diaphragm pump through the foaming outlet end 14 after being foamed by the foaming cavity.

The foaming member 2 includes a plurality of foaming cavities; or, each foaming cavity includes a plurality of sub-cavities; in a foam flowing direction, a foaming channel is arranged between any two adjacent foaming cavities; in addition, a foaming channel is arranged between the gas-liquid mixing tank 21 and the adjacent foaming cavity, so that the plurality of foaming cavities and a plurality of foaming channels are arranged to mix the gas and the liquid fully, so as to form finer foam. According to the design and restriction of foam flowing direction, the foaming channel is at least provided one of horizontally, vertically and obliquely.

The foam outlet end 14 includes a second foam outlet tank 313 and a foam discharge port 312 which communicate with each other, and an outlet of the foaming cavity communicates with an inlet of the foam discharge port 312 through the second foam outlet tank 313; preferably, a foaming channel is arranged between the outlet of the foaming cavity and the second foam outlet tank 313.

### Embodiment 2

As shown in FIGS. 1-7, the embodiment introduces the setting of an integrated diaphragm pump, especially the setting of a foaming member 2 based on Embodiment 1.

The foaming member 2 includes a foaming device 3 and a second stop plate 4, wherein the foaming device 3 is arranged between the first stop plate 1 and the second stop plate 4, and the foaming device 3 forms a foaming cavity through the first stop plate 1 and the second stop plate 4 located at both sides thereof.

The first stop plate 1 is provided with a gas inlet 101 and a first gas inlet 103 which communicate with each other, and the gas inlet 101 communicates with an external gas intake device such as the atmosphere.

Further, the first stop plate 1 is provided with a gas inlet 101 and a plurality of first gas inlets 103, and the first gas inlets 103 are arranged in one-to-one correspondence with the gas bins; the gas inlets 101 communicate with a plurality of first gas inlets 103 through a communication groove 102, and when in use, gas can enter the diaphragm pump through the plurality of first gas inlets 103 respectively only by ventilating the gas inlet 101. The structure is simple, and the gas inlet 101 and the plurality of first gas inlets 103 can be integrally arranged on the first stop plate 1, so as to decrease the parts of the integrated diaphragm pump.

Further, the foaming device 3 is provided with second gas inlet holes 301, and the second gas inlet holes 301 and the first gas inlets 103 are arranged in a one-to-one correspondence and communicate with each other.

Further, the second stop plate 4 is provided with gas intake via holes corresponding to the second gas inlet holes 301 one by one.

As for the process of gas intake: When the gas bin is stretched to increase the volume, the external gas first enters the first gas inlets 103 through the gas inlet 101 and the communication groove 102, and then enters the gas bin after passing through the gas inlet holes on the second gas inlet hole 301 and the second stop plate 4 as well as the gas inlet valve plate sequentially.

Further, the second stop plate 4 is provided with a liquid inlet 401, the foaming device 3 is provided with a liquid inlet tank 302, and the liquid inlet 401 communicates with an external liquid supply device, the liquid inlet tank 302 communicates with the liquid inlet 401, and the liquid inlet tank 302 is arranged corresponding to the liquid inlet valve plate.

Further, the second stop plate 4 is provided with a liquid inlet via hole corresponding to and communicating with the liquid inlet tank 302.

As for the liquid feeding process, when the liquid bin is stretched with the volume increased, the external liquid first enters the liquid inlet tank 302 through the liquid inlet 401, and then enters the liquid bin after passing through a liquid feeding via hole on the second stop plate 4 and the liquid inlet valve plate sequentially.

Further, the foaming device 3 has a first side 316 and a second side 317 which are opposite to each other, wherein the first side 316 is the side, close to the first stop plate 1 of the foaming device 3 and the second side 317 is the side, close to the second stop plate 4, of the foaming device 3.

Furthermore, a first gas outlet hole 303 is arranged on the foaming device 3, and the first gas outlet hole 303 is located in a gas collecting groove which is located at the second side 317 of the foaming device 3; the gas collecting groove is correspondingly arranged with the gas outlet valve plate, the second stop plate 4 is provided with gas outlet via holes corresponding to the gas outlet valve plates one by one, and the gas collecting groove communicates with the gas outlet valve plate through the gas outlet via holes.

As for the process of venting: When the gas bin is compressed so that the volume is decreased, the gas outlet valve plate is opened so that the gas in the gas bin enters the gas collecting groove through vent holes on the gas outlet valve plate and the second stop plate 4, and then passes through the first gas outlet hole 303 to reach the first side 316 of the second stop plate 4.

Further, the second stop plate 4 is also provided with a second gas outlet hole 304 communicating with the first side 316 of the first gas outlet hole 303, and the second gas outlet hole 304 is provided with a check valve, gas can flow from the first side 316 of the second gas outlet hole 304 to the second side 317 of the second gas outlet hole 304 through the check valve, and the second side 317 of the second gas outlet hole 304 communicates with the second side 317 of the first sub-cavity 305.

Further, the first sub-cavity 305 is arranged corresponding to the liquid outlet valve plate, and the second stop plate 4 is provided with the liquid outlet via holes corresponding to the liquid outlet valve plates one by one, so that the liquid outlet valve plate communicates with the first sub-cavity 305.

As for liquid discharge process: When the liquid bin is compressed so that the volume is decreased, the liquid outlet valve plate is opened so that the liquid in the liquid bin enters the second side 317 of the first sub-cavity 305 through the liquid outlet via holes on the liquid outlet valve plate and the second stop plate 4, and is mixed with the gas discharged by the diaphragm pump.

Further, the two sides of the valve plate 5 are respectively provided with a second stop plate 4 and a valve base 6, and the two sides of the valve plate 5 are respectively closely attached to the second stop plate 4 and the valve base 6 located at the two sides thereof; the valve plate 5 is provided with a plurality of via holes, and the liquid outlet valve plate and the gas outlet valve plate are located in the via holes; on one side near the valve base 6, the liquid outlet valve plate and gas outlet valve plate are in the same plane as the valve plate 5, and on the side near the second stop plate 4, the liquid outlet valve plate and the gas outlet valve plate are recessed in the valve plate 5, so that the liquid outlet valve plate and the gas outlet valve plate can only deflect to one side close to the second stop plate 4, so as to open the via holes unidirectionally, and that the gas and liquid in the diaphragm bin of the diaphragm 7 can be discharged from the diaphragm bin of the diaphragm 7 through the liquid outlet valve plate and the gas outlet valve plate respectively; a check valve 12 is arranged at one side, close to the valve base 6, of the liquid outlet valve plate, the check valve 12 is a ball, the valve base 6 is provided with a liquid via hole, and the check valve 12 is at least partially located in the liquid outlet via hole; when the liquid outlet valve plate is in a natural state and does not deflect, the check valve 12 can block the liquid outlet via hole, so that the liquid outlet via hole is in a blocked state to prevent the liquid in the diaphragm bin of the diaphragm 7 from seeping out or flowing back; and when the liquid outlet valve plate deflects to one side close to the second stop plate 4 under the action of pressure difference between two sides, the check valve 12 moves out of the liquid outlet via hole, so that the liquid outlet via hole is in a communication state, and the liquid in the diaphragm bin of the diaphragm 7 can be discharged.

Similarly, the liquid inlet valve plate and the gas inlet valve plate solution are located in the via holes on the valve plate 5; at the side near the valve base 6, the liquid inlet valve plate and the gas inlet valve plate are recessed in the valve plate 5, at the side close to the second stop plate 4, the liquid inlet valve plate and the gas inlet valve plate are in the same plane as the valve plate 5, so that the liquid inlet valve plate and the gas inlet valve plate can only deflect to one side close to the valve base 6, so as to open the via hole unidirectionally, so that the external gas and liquid can enter the diaphragm bin of the diaphragm 7 through the liquid inlet valve plate and gas inlet valve plate respectively.

Further, the foaming device 3 forms a hollow cavity through the first stop plate 1 and the second stop plate 4 located on both sides of the foaming device 3, and the cavity communicates with the liquid outlet valve plate and the gas outlet valve plate; the cavity is also provided with a foam discharge port 312 and are internally provided with the sub-cavities are arranged in parallel, each sub-cavity is internally provided with a filter screen, and a foam channel is arranged between each sub-cavity and the adjacent sub-cavity; and after the liquid in the liquid bin and the gas in the gas bin can pass through the filter screen in each sub-cavity sequentially through the foam channel after entering the cavity through the liquid outlet valve plate and the gas outlet valve plate, respectively.

A plurality of sub-cavities are arranged in parallel in the cavities, and each sub-cavity is provided with a filter screen. Therefore, by changing the arrangement mode of the filter screen and changing the trend of foam according to the present application, the foam can pass through each filter screen sequentially, so that the volume of the foaming device 3 can be very small, and the application scope of the foaming device 3 can be improved. In addition, the foaming device 3 has the advantages of simple structure and convenient preparation.

Further, the foaming device 3 includes a closed side wall and a plurality of filter screens arranged in parallel in the side wall, the first stop plate 1 and the second stop plate 4 are respectively attached to both sides of the side wall, and a hollow cavity is formed by the first stop plate 1, the second stop plate 4 and the side wall. The filter screens are separated by a partition plate 318, and the two end faces of the partition plate 318 are hermetically connected to the first stop plate 1 and the second stop plate 4, respectively, to divide the cavity into a plurality of sub-cavities arranged in parallel.

Further, a foam channel is arranged between each sub-cavity and adjacent sub-cavity, and the foam channels are alternately arranged on both sides of the filter screen respectively according to the order of liquid and gas flowing through each sub-cavity, so that liquid and gas can pass through the filter screen in each sub-cavity sequentially through the foam channel.

Preferably, the foam channel is arranged on the partition plate 318 between two adjacent sub-cavities, and comprises a first foam channel, a second foam channel, a third foam channel and a fourth foam channel, wherein the first foam channel is a barrier arranged between two adjacent sub-cavities, and the height of the barrier is lower than that of the partition plate 318, so that the barrier is not connected with the first stop plate 1 or the second stop plate 4, thereby forming the first foam channel through which foam can flow. The second foam channel is a via hole on the partition plate 318 between adjacent sub-cavities. The third foam channel is a gap on the partition plate 318 between the adjacent sub-cavities. The fourth foam channel is formed by eliminating the partition plate 318 disposed between adjacent sub-cavities.

Preferably, in the same foaming device 3, the foam channel can be one of the first foam channel, the second foam channel, the third foam channel and the fourth foam channel, or several of the first foam channel, the second foam channel, the third foam channel and the fourth foam channel.

Specifically, the number of sub-cavities is recorded as n, and the sub-cavities are sequentially recorded as first sub-cavity 305, second sub-cavity 307, third sub-cavity 308 . . . m^{th} sub-cavity, (m+1)^{th} sub-cavity . . . n^{th} sub-cavity, where n≥2, 1≤m≤n, correspondingly, the first sub-cavity 305 is provided with a first filter screen, the second sub-cavity 307 is provided with a second filter screen, . . . , the n^{th} sub-cavity is provided with an n^{th} filter screen, which is located in the middle of the partition plate 318, and each sub-cavity is divided into two parts. According to the division of two sides of the foaming device 3, one side of each sub-cavity near the first stop plate 1 is designated as the first side 316, and the other side of each sub-cavity near the second stop plate 4 is designated as the second side 317.

If the liquid and the gas enter the first sub-cavity 305 from the second side 317 in the first sub-cavity 305, the foam channel between the first sub-cavity 305 and the second sub-cavity 307 is provided at the first side of the partition plate 318 between the first sub-cavity 305 and the second sub-cavity 307, and the liquid and gas will pass through the first filter screen after passing through the first sub-cavity 305, and then enter the second sub-cavity 307 through the foam channel between the first sub-cavity 305 and the second sub-cavity 307, so as to initially form foam, and then passes through the second filter screen and enters the third sub-cavity 308 through the foam channel arranged between the second sub-cavity 307 and the third sub-cavity 308; the foam channel between the second sub-cavity 307 and the third sub-cavity 308 is located at the first side 316 of the partition plate 318 between the second sub-cavity 307 and the third sub-cavity 308 for continuous foaming . . . in this way, passes through the first filter screen, the second filter screen, . . . and the n^{th} filter screen sequentially till the foaming process is finished, and is discharged from the foam discharge port 312.

Preferably, the number of sub-cavities is 2 to 10.

The first stop plate 1 and the second stop plate 4 are arranged on both sides of the side wall in parallel, and the side wall, the first stop plate 1 and the second stop plate 4 form a hollow cavity inside, and the filter screen in each sub-cavity can be arranged in parallel with the first stop plate 1 or the second stop plate 4 or obliquely between the first stop plates 1 or the second stop plates 4. The first stop plate 1 and the second stop plate 4 can be separately prepared and assembled with the side wall, or can be integrally formed.

Preferably, the filter screen is arranged in parallel with the first stop plate 1 or the second stop plate 4.

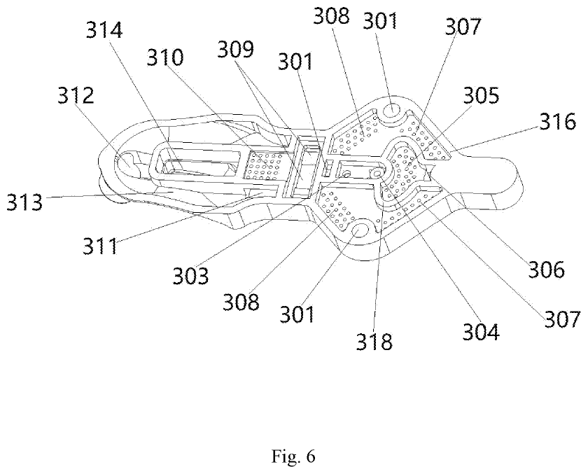

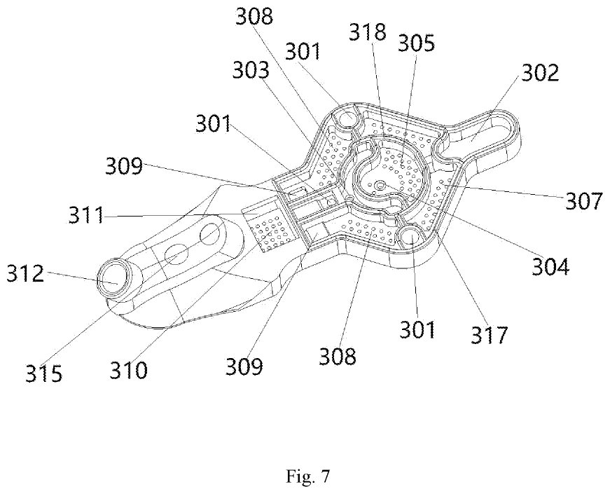

Preferably, as shown in FIGS. 6-7, four filter screens are arranged in the cavity in parallel, namely the first filter screen, the second filter screen, the third filter screen and the fourth filter screen, which are separated by partition plate 318 to form four sub-cavities, including the first sub-cavity 305, the second sub-cavity 307, the third sub-cavity 308 and the fourth sub-cavity 310.

When the volume of the liquid bin is reduced, the liquid in the liquid bin will enter the second side 317 of the first sub-cavity 305 sequentially through the check valve 12, the valve base 6, the liquid outlet valve plate and second stop plate 4; when the volume of the gas bin is reduced, the gas in the gas bin will enter the second side 317 of the first gas outlet hole 303 through the valve base 6, the gas outlet valve plate and the second stop plate 4 sequentially, and then the first side 316 of the second gas outlet hole 304 through the first gas outlet hole 303, and finally the second side 317 of the first sub-cavity 305 through the second gas outlet hole 304 and the first sub-cavity 305, thereby meeting the liquid at the second side 317 of the first sub-cavity 305 for preliminarily mixing to form the foam.

For convenience of corresponding to Embodiment 1, it should be specially noted that the second side 317 of the first sub-cavity 305 is the gas-liquid mixing tank 21 in Embodiment 1; all sub-cavities, except the second side 317 of the first sub-cavity 305, are foaming cavities in Embodiment 1, and the filter holes and foam channels of the filter screen are foaming channels in Embodiment 1.

Further, the foam on the second side 317 of the first sub-cavity 305 enters the first side 316 of the first sub-cavity 305 through the first filter screen under the pressure difference, the first side 316 of the first sub-cavity 305 communicates with the second side 317 of the second sub-cavity 307 through the first foam outlet 306, so that the gas can enter the second side 317 of the second sub-cavity 307 through the first foam outlet 306, and then enter the first side 316 of the second sub-cavity 307 through the second filter screen. No partition plate 318 is provided between the first side 316 of the second sub-cavity 307 and the first side 316 of the third sub-cavity 308, so that the first side 316 of the second sub-cavity 307 is in direct communication with the first side 316 of the third sub-cavity 308. The foam from the first side 316 of the second sub-cavity 307 can flow to the first side 316 of the third sub-cavity 308, then enter the second side 317 of the third sub-cavity 308 through the third filter screen, and the second side 317 of the third sub-cavity 308 communicates with the first side 316 of the fourth sub-cavity 310 through the second foam outlet 309. Therefore, the foam from the second side 317 of the third sub-cavity 308 can enter the first side 316 of the fourth sub-cavity 310 through the second foam outlet 309, and then enter the second side 317 of the fourth sub-cavity 310 through the fourth filter screen, and the second side 317 of the fourth sub-cavity 310 communicates with the second foam outlet tank 313 through the third foam outlet 311. Therefore, the foam from the second side 317 of the third sub-cavity 308 can enter the first side 316 of the fourth sub-cavity 310 through the second foam outlet 309, and then enter the second side 317 of the fourth sub-cavity 310 through the fourth filter screen, and the second side 317 of the fourth sub-cavity 310 communicates with the second foam outlet tank 313 through the third foam outlet 311. Therefore, the foam from the second side 317 of the fourth sub-cavity 310 can enter the second foam outlet tank 313 provided with a foam discharge port 312 through the third foam outlet 311, and the foam in the second foam outlet tank 313 is finally discharged out of the pump through the foam discharge port 312 on the second foam outlet tank 313.

The first foam outlet 306, the second foam outlet 309 and the third foam outlet 311 are all via holes, and a part of foam channels are formed through the first foam outlet 306, the second foam outlet 309 and the third foam outlet 311.

As some embodiments of the present application, the second foam outlet tank 313 is arranged around the fourth sub-cavity 310, two third foam outlets 311 are arranged on the fourth sub-cavity 310, and the two sides of the fourth sub-cavity 310 respectively communicate with the second foam outlet tank 313 through the third foam outlet 311.

As some embodiments of the present application, the second foam outlet tank 313 is provided along one side of the fourth sub-cavity 310, one side of the fourth sub-cavity 310 is provided with a third foam outlet 311, and the fourth sub-cavity 310 communicates with the second foam outlet tank 313 through the third foam outlet 311.

Further, the diaphragm pump is covered with an outer casing, the foaming device 3 is provided with an accommodation groove 314, the second foam outlet tank 313 is provided around the fourth sub-cavity 310 and the accommodation groove 314, and the sensing device 2 is provided in the accommodation groove 314.

Preferably, the sensing device 2 is an infrared sensing device, and comprises an infrared transmitter and an infrared receiver.

More preferably, a sensing window 315 is provided at the bottom of the accommodation groove 314, the sensing window 315 is exposed through a via hole in the outer casing, and the sensing device 2 controls the diaphragm pump to open or close when a user places his/her hand within a sensing area of the sensing window 315.

Correspondingly, the first stop plate 1 is provided with a mounting hole 104 and a first foam outlet tank 106, the mounting hole 104 is arranged corresponding to the accommodation groove 314, and the mounting hole 104 is a via hole; the first foam outlet tank 106 is provided corresponding to the second foam outlet tank 313, and the first stop plate 1 covers the first side 316 of the foaming device 3, so that the sensing device 2 in the accommodation groove 314 can extend out of the mounting hole 104 and can be connected with other components; and the first foam outlet tank 106 and the second foam outlet tank 313 are relatively provided, and the first foam outlet tank 106 covers the second foam outlet tank 313 to form a foam discharge channel from the fourth sub-cavity 310 to the foam discharge port 312.

Further, one side, close to the foaming device 3, of the first stop plate 1 is provided with a convex rib, which is provided corresponding to the partition plate 318 between the sub-cavities, so that each sub-cavity can be relatively independent and has a good sealing performance.

Further, the integrated diaphragm pump further comprises a valve base 6, a diaphragm mount 8, a rotor compartment 9 and a connector 11, wherein one side of the valve plate 5 is closely fitted to the second stop plate 4, and the other side thereof is closely fitted to the valve base 6; and the diaphragm 7 is fixedly arranged in the diaphragm mount 8, and an output shaft of the motor 10 is located in the rotor compartment 9.

Furthermore, the first stop plate 1, the foaming device 3, the second stop plate 4, the valve plate 5, the valve base 6, the diaphragm 7, the diaphragm mount 8 and the rotor compartment 9 are secured together through the connector 11. Specifically, both ends of the connector 11 are provided with clamping jaws, the first stop plate 1 is provided with a clamping groove 105, and a side wall of the rotor compartment 9 is provided with a clamping part and the clamping jaws of the connector 11 are respectively connected with the clamping groove 105 and the clamping part.

### Embodiment 3

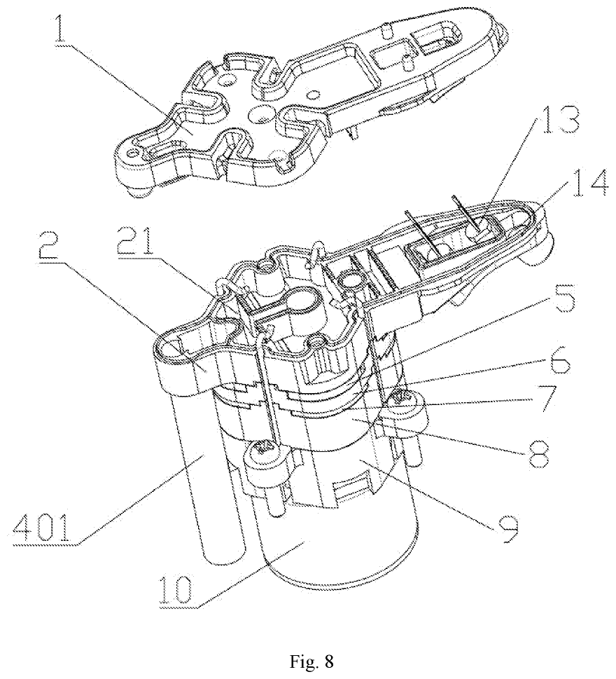

As shown in FIGS. 8-11, the embodiment introduces the installation of the integrated diaphragm pump based on Embodiment 1 or Embodiment 2, especially another structural installation of foaming member 2.

First of all, it should be noted that most of the structures of the integrated diaphragm pump in the embodiment are the same as those in Embodiment 1 and Embodiment 2, and will not be repeated here; the difference of the embodiment lies in that the foaming device and the second stop plate in Embodiment 2 are integrated to form an integrated foaming member 2, the structures of the integrated foaming member 2 and the first stop plate 1 are improved, that is, another form of foaming structure is provided to further optimize the structure of the integrated diaphragm pump, so as to decrease the parts, lower the assembly difficulty and shorten the volume thereof; to be specific:

In the embodiment, no second stop plate is required, the foaming member 2 is an integral part: one end face of the foaming member 2 is connected with the first stop plate 1, and the other end face thereof is connected with the valve plate 5; and the liquid inlet tank 302, the gas-liquid mixing tank 21, the foaming cavity and the second foam outlet tank 313 are arranged on one side of foaming member 2 towards the first stop plate 1.

The flow of liquid is basically the same as that in Embodiment 2. The liquid inlet tank 302 is connected with an external liquid supply mechanism through a liquid inlet 401, and the liquid inlet tank 302 is provided with a liquid outlet 22, through which the liquid inlet tank 302 communicates with the liquid bin of diaphragm 7, so that the external liquid can enter the liquid bin.

The flow of gas is basically the same as that in Embodiment 2. The gas passes through the gas inlet 101, the first gas inlet 103 and the second gas inlet hole 301 sequentially and enters the gas bin of the diaphragm 7.

The gas-liquid mixing tank 21 is provided with a liquid inlet opening 23 and a gas inlet opening 24, the liquid inlet opening 23 communicates with the liquid bin, and the gas inlet opening 23 communicates with the gas bin; therefore, driven by the motor 10, the liquid in the liquid bin enters the gas-liquid mixing tank 21 through the liquid inlet opening 23, and the gas in the gas bin enters the gas-liquid mixing tank 21 through the gas inlet opening 23; and in gas-liquid mixing tank 21, the gas and the liquid are mixed for foaming to form the foam.

A lower partition plate 28 is arranged between the gas-liquid mixing tank 21 and the adjacent foaming cavity, and a second tooth structure 29 is arranged at one end, towards the first stop plate, of the lower partition plate 28; the second tooth structure 29 has tooth gaps, through which the foam formed in the gas-liquid mixing tank 21 flows from the gas-liquid mixing tank 21 to the adjacent foaming cavity.

The foaming member 2 comprises a plurality of foaming cavities, and a lower partition plate 28 is arranged between any two adjacent foaming cavities in a foam flowing direction. One end, towards the first stop plate, of the lower partition plate 28 is provided with a second tooth structure 29, and the second tooth structure 29 has tooth gaps, and the foam flows from the last foaming cavity to the next foaming cavity through the tooth gaps of the second tooth structure 29.

The lower partition plate 28 is arranged between the second foam outlet tank 313 and the adjacent foaming cavity, one end, towards the first stop plate, of the lower partition plate 28 is provided with the second tooth structure 29 which has the tooth gaps, and the foam fully foamed by the foaming cavity flows from the foaming cavity to the second foam outlet tank 313 through the tooth gaps of the second tooth structure 29, and is discharged through the foam discharge port 312.

In order to correspond to the features of Embodiment 1, it should be noted that the tooth gaps of the second tooth structure 29 are foaming channels.

In addition, as an equivalent variation of the technical solution, the lower partition plate 28 may not be provided with a tooth structure, but the lower partition plate 28 may be provided with a hole structure or a gap structure, and the hole structure or the gap structure is used as the foaming channel: the arrangement and shape thereof are conventional choices, for example, the hole or gap structure is provided at the middle, top and bottom of the lower partition plate 28, and the holes are of a round, square or irregular shape, and the gaps are of an arc, square or irregular shape and the like.

Preferably, three foaming cavities are provided in in the embodiment, including a first foaming cavity 25, a second foaming cavity 26 and a third foaming cavity 27, are provided in the foam flowing direction; the first foaming cavity 25 is provided adjacent to the gas-liquid mixing tank 21, and the third foaming cavity 27 is provided adjacent to the second foam outlet tank 313.

In addition, in order to further strengthen the foaming effect, one side, towards the foaming member 2, of the first stop plate 1 is provided with an upper partition plate 107, and the upper partition plate 107 extends into the foaming cavity; one end, near the foaming member 2, of each upper partition plate 107 is provided with a first tooth structure 108 which has tooth gaps; and therefore, in foaming cavity, at least one layer of tooth gap structure is added to the flow of foam, which is conducive to enhancing the foaming effect and making the foam richer and finer.

The first stop plate 1 may be provided with the upper partition plate 107 or a plurality of upper partition plates 107; preferably, the first stop plate 1 is provided with the plurality of upper partition plates 107, the upper partition plates 107 are in one-to-one correspondence with the foaming cavities, and the upper partition plates 107 extend into the foaming cavities.

The tooth gaps of the first tooth structure 108 of each upper partition plate 107 may also be regarded as the foaming channels, which can be also structurally deformed similar to the foaming channel of the lower partition plate 28, and will not be repeated here.

What has been described above only involves the preferred embodiment of the present invention, and is not intended to limit the present invention. Any modification, equivalent replacement and improvement made within the spirit and principle of the present invention should fall into the scope of protection of the present invention.

1. An integrated diaphragm pump, which is characterized in that comprising a first stop plate (1), a foaming member (2), a valve plate (5), a diaphragm (7) and a motor (10), all of which are arranged sequentially, wherein the foaming member (2) comprises a gas-liquid mixing tank (21) and a foaming cavity, and an outlet of the gas-liquid mixing tank (21) communicates with the foaming cavity for mixing gas and liquid and foaming through the foaming cavity thereof.

2. The integrated diaphragm pump according to claim 1, which is characterized in that the foaming member (2) comprises a plurality of foaming cavities, and a foaming channel is arranged between any two adjacent foaming cavities along the foam flowing direction.

3. The integrated diaphragm pump according to claim 2, which is characterized in that a foaming channel is arranged between the gas-liquid mixing tank (21) and the adjacent foaming cavity.

4. The integrated diaphragm pump according to claim 2, which is characterized in that the foaming member (2) comprises a foam outlet end (14), the foam outlet end (14) comprises a second foam outlet tank (313) and a foam discharge port (312) which communicate with each other, an outlet of each foaming cavity communicates with an inlet of the foam discharge port (312) through a second foaming outlet tank (313), and a foaming channel is arranged between an outlet of the corresponding foaming cavity and the second foaming outlet tank (313).

5. The integrated diaphragm pump according to claim 2, which is characterized in that the foaming channel is at least provided one of horizontally, vertically and obliquely.

6. The integrated diaphragm pump according to claim 1, which is characterized in that the foaming member (2) comprises a foaming device (3) and a second stop plate (4), the foaming device (3) is arranged between the first stop plate (1) and the second stop plate (4), and the foaming device (3) forms a foaming cavity through the first stop plate (1) and the second stop plates (4) located at both sides thereof.

7. The integrated diaphragm pump according to claim 6, which is characterized in that each foaming cavity comprises a plurality of sub-cavities, each sub-cavity is internally provided with a filter screen, and a foam channel is provided between each sub-cavity and the adjacent sub-cavity, through which liquid and gas can pass through the filter screen in each sub-cavity in turn.

8. The integrated diaphragm pump according to claim 1, which is characterized in that the foaming member (2) is integrally formed and comprises a plurality of foaming cavities, and a lower partition plate (28) is arranged between any two adjacent foaming cavities, and each lower partition plate (28) is provided with a foaming channel.

9. The integrated diaphragm pump according to claim 8, which is characterized in that one end, towards the first stop plate, of the lower partition plate (28) is provided with a second tooth structure (29) which has tooth gaps.

10. The integrated diaphragm pump according to claim 1, which is characterized in that one side, towards the foaming member (2), of the first stop plate (1) is provided with an upper partition plate (107), the upper partition plate (107) extends into the foaming cavity, and one end, near the foaming member (2), of the upper partition plate (107) is provided with a first tooth structure (108) which has tooth gaps.
